(19) United States
(12) Patent Application Publication
(10) Pub. No.: US 2026/0118468 A1
(43) Pub. Date: Apr. 30, 2026

(54) ESTIMATION DEVICE, MOBILE OBJECT, EARTH STATION, SYSTEM, METHOD, AND PROGRAM THAT ESTIMATE POSITION OF SIGNAL GENERATION SOURCE

(71) Applicant: ArkEdge Space Inc., Tokyo (JP)

(72) Inventor: Ryohei TAKAHASHI, Koto-ku, Tokyo (JP)

(73) Assignee: ArkEdge Space Inc., Tokyo (JP)

(21) Appl. No.: 19/142,083

(22) PCT Filed: Nov. 27, 2024
(86) PCT No.: PCT/JP2024/042041

§ 371 Date: Jun. 20, 2025

(30) Foreign Application Priority Data
Apr. 30, 2024 (JP) 2024-073448

(51) Int. Cl. G01S 5/02

(52) U.S. Cl. CPC G01S 5/0246; G01S 5/0226

(57) ABSTRACT

To provide an estimation device and the like configured to estimate a position of a signal generation source. An estimation device including a device configured to determine frequency characteristics of signals received by a single mobile object at a plurality of reception times, a device configured to determine, with respect to a reception time pair that is a pair of two reception times of the plurality of reception times, frequency-correlation value characteristics indicating a relationship between a frequency and a correlation value between the frequency characteristics corresponding to the two reception times included in the reception time pair, a device configured to calculate, with respect to the reception time pair, an assumed Doppler frequency change amount at a potential estimated position of the signal generation source based on positions and velocities of the mobile object at the two reception times included in the reception time pair, a device configured to determine, with respect to the reception time pair, potential estimated position-correlation value characteristics indicating a relationship between the potential estimated position and the correlation value based on the frequency-correlation value characteristics and the assumed Doppler frequency change amount related to the reception time pair, and a device configured to determine an estimated position of the signal generation source based on one or more of the potential estimated position-correlation value characteristics corresponding to one or more of the reception time pairs.

### TECHNICAL FIELD

The present disclosure relates to an estimation device, a mobile object, an earth station, a system, a method, and a program that estimate a position of a signal generation source.

### BACKGROUND ART

A method of estimating a position of a transmission source of a radio wave using a Doppler frequency in a satellite system is known (for example, Patent Document 1). In Patent Document 1, a radio wave at each transmission position is restored from an assumed Doppler change amount, a reception time delay, and a reception time, a matching degree is calculated, and a position with a high matching degree is determined as an estimated position of a transmission source of the radio wave.

### CITATION LIST

### Patent Literature

Patent Document 1: U.S. Pat. No. 11,480,649

### SUMMARY OF THE INVENTION

### Technical Problem

However, in the method described in Patent Document 1, it is necessary to accurately calculate a shift amount due to the Doppler effect in order to restore the original radio wave. An error easily occurs at a stage of calculating a shift amount from an acquired signal and it is difficult to accurately estimate a position of a transmission source.

The present invention has been made to solve the above-described problem, and an object thereof is to estimate a position of a signal transmission source without the need to accurately calculate a Doppler shift amount.

### Means for Solving the Problem

1. According to an embodiment of the present invention, there is provided an estimation device configured to estimate a position of a signal generation source, the estimation device including a frequency characteristics determination device configured to determine frequency characteristics of signals received by a single mobile object at a plurality of reception times, a frequency-correlation value characteristics determination device configured to determine, with respect to a reception time pair that is a pair of two reception times of the plurality of reception times, frequency-correlation value characteristics indicating a relationship between a frequency and a correlation value between the frequency characteristics corresponding to the two reception times included in the reception time pair, an assumed Doppler frequency change amount calculation device configured to calculate, with respect to the reception time pair, an assumed Doppler frequency change amount at a potential estimated position of the signal generation source, based on positions and velocities of the mobile object at the two reception times included in the reception time pair, a potential estimated position-correlation value characteristics determination device configured to determine, with respect to the reception time pair, potential estimated position-correlation value characteristics indicating a relationship between the potential estimated position and the correlation value, based on the frequency-correlation value characteristics and the assumed Doppler frequency change amount related to the reception time pair, and an estimated position determination device configured to determine an estimated position of the signal generation source, based on one or more of the potential estimated position-correlation value characteristics corresponding to one or more of the reception time pairs.

2. In the estimation device according to item 1, the estimated position determination device may determine, as the estimated position of the signal generation source, a potential estimated position at which a value calculated by using a function having, as arguments, correlation values determined based on estimated potential position-correlation value characteristics corresponding to a plurality of the reception time pairs is equal to or larger than a predetermined value.

3. In the estimation device according to item 2, the function is a function of calculating an integral value of the arguments.

4. In the estimation device according to any one of items 1 to 3, one of the two reception times included in each of a plurality of the reception time pairs may be a reception time common to the plurality of reception time pairs, and the other reception time may be a reception time different for each pair.

5. In the estimation device according to any one of items 1 to 3, none of the two reception times included in each of the plurality of reception time pairs may be a reception time common to the plurality of reception time pairs.

6. According to an embodiment of the present invention, there is provided a mobile object including the estimation device according to any one of items 1 to 5.

7. According to an embodiment of the present invention, there is provided an earth station including the estimation device according to any one of items 1 to 5.

8. According to an embodiment of the present invention, there is provided an estimation system including one or more mobile objects and one or more earth stations and configured to estimate a position of a signal generation source, the estimation system including a frequency characteristics determination device configured to determine frequency characteristics of signals received by a single mobile object at a plurality of reception times, a frequency band-correlation value characteristics determination device configured to determine, with respect to a reception time pair that is a pair of two reception times of the plurality of reception times, frequency-correlation value characteristics indicating a relationship between a frequency and a correlation value between the frequency characteristics corresponding to the two reception times included in the reception time pair, an assumed Doppler frequency change amount calculation device configured to calculate, with respect to the reception time pair, an assumed Doppler frequency change amount at a potential estimated position of the signal generation source, based on positions and velocities of the mobile object at the two reception times included in the reception time pair, a potential estimated position-correlation value characteristics determination device configured to determine, with respect to the reception time pair, potential estimated position-correlation value characteristics indicating a relationship between the potential estimated position and the correlation value, based on the frequency-correlation value characteristics and the assumed Doppler frequency change amount related to the reception time pair, and an estimated position determination device configured to determine an estimated position of the signal generation source, based on one or more of the potential estimated position-correlation value characteristics corresponding to one or more of the reception time pairs.

9. In the estimation system according to item 8, each of the devices may be included in either of the one or more mobile objects or the one or more earth stations.

10. In the estimation system according to item 8, each of the devices may be provided in a distributed manner in the one or more mobile objects and the one or more earth stations.

11. According to an embodiment of the present invention, there is provided a method of estimating a position of a signal generation source, the method including causing one or more computers to determine frequency characteristics of signals received by a single mobile object at a plurality of reception times, to determine, with respect to a reception time pair that is a pair of two reception times of the plurality of reception times, frequency-correlation value characteristics indicating a relationship between a frequency and a correlation value between the frequency characteristics corresponding to the two reception times included in the reception time pair, to calculate, with respect to the reception time pair, an assumed Doppler frequency change amount at a potential estimated position of the signal generation source, based on positions and velocities of the mobile object at the two reception times included in the reception time pair, to determine, with respect to the reception time pair, potential estimated position-correlation value characteristics indicating a relationship between the potential estimated position and the correlation value, based on the frequency-correlation value characteristics and the assumed Doppler frequency change amount related to the reception time pair, and to determine an estimated position of the signal generation source, based on one or more of the potential estimated position-correlation value characteristics corresponding to one or more of the reception time pairs.

12. According to an embodiment of the present invention, there is provided a program configured to cause one or more computers to execute the method described in item 11.

### Advantageous Effects of Invention

According to the embodiment of the present invention, it is possible to estimate a position of a signal transmission source without calculating a Doppler shift amount.

### BRIEF DESCRIPTION OF DRAWINGS

FIG. 1 is a diagram illustrating a configuration of a position estimation system according to an embodiment.

FIG. 2 is a diagram illustrating a detailed configuration of a mobile object including an estimation device and an earth station.

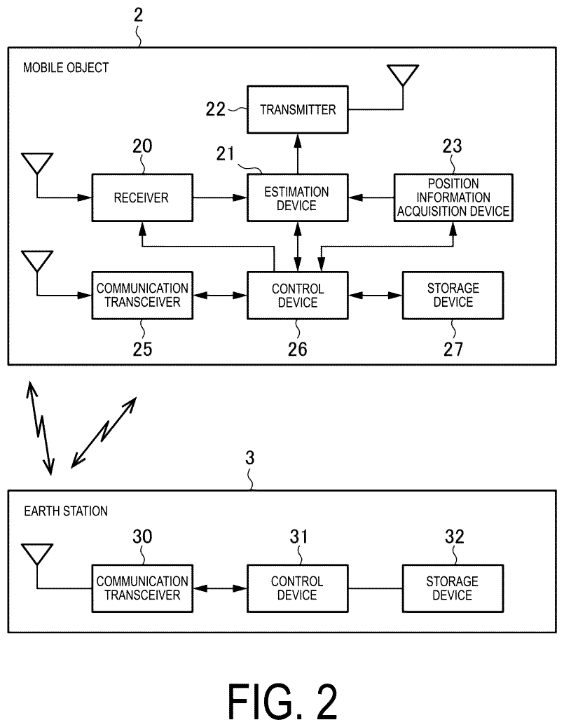

FIG. 3 is a diagram illustrating a detailed configuration of the estimation device.

FIG. 4 illustrates an example of an operation flowchart of the estimation system including the estimation device according to the embodiment.

FIG. 5 illustrates an example of a time-axis waveform of a reception radio wave or Terahertz wave received by the mobile object.

FIG. 6A illustrates an example of frequency characteristics of a reception signal at a reception time to in the embodiment.

FIG. 6B illustrates an example of frequency characteristics of a reception signal at a reception time t₁ in the embodiment.

FIG. 7 is a diagram for describing the concept of signal correlation processing.

FIG. 8 illustrates an example of frequency-correlation value characteristics (time t₀-time t₁) in the embodiment.

FIG. 9A illustrates an example of assumed Doppler frequency change amount characteristics (time t₀-time t₁) in the embodiment.

FIG. 9B illustrates an example of assumed Doppler frequency change amount characteristics (time t₀-time t₂) in the embodiment.

FIG. 9C illustrates an example of assumed Doppler frequency change amount characteristics (time t₀-time t₃) in the embodiment.

FIG. 10A illustrates an example of potential estimated position-correlation value characteristics (time t₀-time t₁) in the embodiment.

FIG. 10B illustrates an example of potential estimated position-correlation value characteristics (time t₀-time t₂) in the embodiment.

FIG. 10C illustrates an example of potential estimated position-correlation value characteristics (time t₀-time t₃) in the embodiment.

FIG. 11 illustrates an example of integral value characteristics of correlation value characteristics in the embodiment.

### DESCRIPTION OF EMBODIMENTS

An estimation device, a mobile object, an earth station, a system, a method, and a program that estimate a position of a signal generation source according to embodiments of the present invention will be described with reference to the drawings.

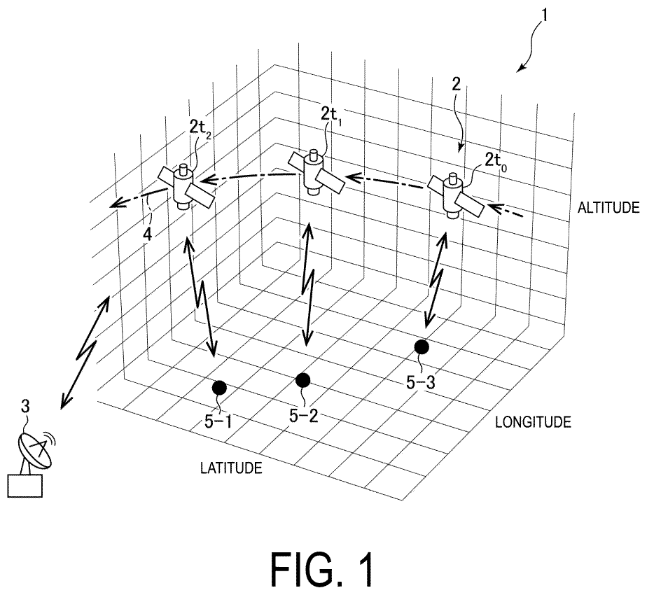

FIG. 1 is a diagram illustrating a configuration of an estimation system according to the present embodiment, and the estimation system estimates a position of a signal generation source. As will be described in detail below, an estimation system 1 illustrated in FIG. 1 is a system that receives a signal such as a radio wave or Terahertz wave and estimates a position of a signal generation source based on the received signal. The estimation system 1 can be used as a radio wave or Terahertz wave monitoring system.

The estimation system 1 includes a mobile object 2 and an earth station 3. The mobile object 2 receives a signal such as a radio wave or Terahertz wave, and an estimation device provided in the mobile object 2 estimates a position of a signal generation source based on the received signal. Information related to the estimated position can be transmitted to the earth station 3. Examples of the mobile object 2 may include an artificial satellite, and an aircraft such as an unmanned aircraft, and the mobile object 2 may receive such as radio waves or Terahertz waves, while moving. In this specification, the mobile object 2 is an artificial satellite. Artificial satellites can orbit the earth on satellite orbits. The satellite orbits may be, for example, a low earth orbit (LEO), a middle earth orbit (MEO), or a geostationary earth orbit (GEO), but the present invention is not particularly limited thereto. In FIG. 1, the mobile object 2 moves along a predetermined satellite orbit 4. For example, the mobile object 2 is located at a position 2t₀ at time to, moves to a position 2t₁ at time t₁, and moves to a position 2t₂ at time t₂. Although only one mobile object 2 is illustrated in FIG. 1, the estimation system 1 may include a plurality of mobile objects 2.

The estimation system 1 aims at estimating positions of signal generation sources 5-1, 5-2, and 5-3 whose positions are unknown. The number of signal generation sources may be one or plural. Although the estimation system 1 may include a plurality of mobile objects 2, a position of a signal generation source can be estimated based on a signal received by a single mobile object 2. In FIG. 1, a coordinate system indicating a latitude and a longitude, and an altitude from the sea surface is illustrated.

The mobile object 2 includes a receiver 20, an estimation device 21, a transmitter 22, a position information acquisition device 23, a communication transceiver 25, a control device 26, and a storage device 27, and may include other constituent elements that enable various functions. The constituent elements can include a power supply system subsystem that supplies power to each of devices mounted on the mobile object 2 and that includes a solar panel, a battery, and the like, an attitude control system subsystem that controls an attitude of the mobile object 2, a propulsion system subsystem that propels the mobile object 2, a thermal control system subsystem that controls a temperature range in the mobile object 2, and the like.

The receiver 20 is a device that receives a signal such as a radio wave or Terahertz wave and includes a reception antenna. Examples of the radio wave or Terahertz wave referred to here may include electromagnetic waves having frequencies equal to or lower than 3 THz, but the present invention is not limited thereto. For example, instead of the radio wave or Terahertz wave, infrared light or any other light having a waveform to be Doppler-shifted may be used. The receiver 20 receives, for example, a radio wave or Terahertz wave arriving from the earth. Although the expression “from the earth” means “from the ground and/or the sea” in the present embodiment, radio waves or Terahertz waves that can be received by the receiver 20 are not limited thereto. That is, a transmission source of a radio wave or Terahertz wave may include a facility installed on the ground, a mobile object that can move on the ground, a ship on the sea, a flying object above the ground surface or the sea surface, and a spacecraft in outer space. Here, the receiver 20 converts the received analog radio wave or Terahertz wave signal into a digital signal indicating a time-axis waveform of the radio wave or Terahertz wave signal and outputs the digital signal.

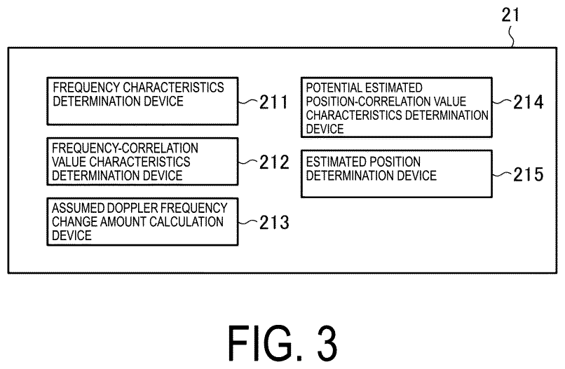

The estimation device 21 is constituted by one or more computers and/or one or more processing circuits and storage devices and estimates a position of a signal generation source based on the received radio wave or Terahertz wave signal or the like. A more detailed configuration of the estimation device 21 is illustrated in FIG. 3. As illustrated in FIG. 3, the estimation device 21 includes a frequency characteristics determination device 211, a frequency-correlation value characteristics determination device 212, an assumed Doppler frequency change amount calculation device 213, a potential estimated position-correlation value characteristics determination device 214, and an estimated position determination device 215. These devices may be implemented by executing a program stored in the storage device included in the estimation device 21 by the one or more computers and/or the one or more processing circuits, or these functions may be enabled by hardware configuring an electronic circuit or the like for enabling a part or all of each function.

The frequency-correlation value characteristics determination device 212 determines frequency characteristics of signals received by one mobile object at a plurality of reception times. With respect to a reception time pair with two reception times, among a plurality of reception times, considered as one pair, the frequency-correlation value characteristics determination device 212 determines frequency-correlation value characteristics indicating a relationship between a frequency and a correlation value between frequency characteristics of the two reception times included in the reception time pair. The assumed Doppler frequency change amount calculation device 213 calculates, with respect to the reception time pair, a Doppler frequency change amount assumed at a potential estimated position of the signal generation source based on positions and velocities of the mobile object at the two reception times of the reception time pair. The potential estimated position-correlation value characteristics determination device 214 determines, with respect to the reception time pair, potential estimated position-correlation value characteristics indicating a relationship between the potential estimated position and the correlation value based on the frequency-correlation value characteristics and the assumed Doppler frequency change amount for the reception time pair. The estimated position determination device 215 determines an estimated position of the signal generation source based on the potential estimated position-correlation value characteristics for one or more pairs of reception times.

In one embodiment, the estimated position determination device 215 may determine, as the estimated position of the signal generation source, a potential estimated position for which a value calculated by a function having, as arguments, correlation values determined based on estimated potential position-correlation value characteristics for a plurality of reception time pairs is equal to or larger than a predetermined value. A plurality of potential estimated positions may be determined as the estimated position of the signal generation source. As another embodiment, a potential estimated position having the highest value calculated by the function having the correlation values as the arguments may be determined as the estimated position of the signal generation source. The estimated position can be specified by a latitude and a longitude and may be a region having a certain range represented by a latitude and a longitude.

The function having the correlation values as the arguments may be a function of calculating an integral value of the arguments. An example of the value calculated by the function having the correlation values as the arguments is a total value of the correlation values. It is also possible to use a function that integrates a value obtained by multiplying each correlation value by a weighting coefficient determined for the correlation value. The function may be any function as long as the function determines a value indicating the magnitude of correlation at the position based on a plurality of correlation values.

One of the two reception times of each pair of the plurality of reception time pairs may be a reception time common to the plurality of reception time pairs, and the other reception time may be a reception time different for each pair. Furthermore, in another embodiment, none of the two reception times of each pair of the plurality of reception time pairs may be a reception time common to the plurality of reception time pairs.

In the present embodiment, it is assumed that the estimation device 21 acquires, from the position information acquisition device 23, its own position and velocity that are used in calculation of the Doppler frequency change amount to be assumed at the potential estimated position of the signal generation source. Here, the velocity includes a moving direction. In another embodiment, the own position and velocity of the mobile object may be determined based on a predetermined route and time of the mobile object or may be acquired from another device such as the earth station 3.

The estimation device 21 outputs the estimated position to the transmitter 22. The transmitter 22 is a device that transmits information related to the estimated position of the signal generation source input from the estimation device 21 and includes a transmission antenna. The transmitter 22 transmits the estimated position information to, for example, the earth station 3. Instead of the transmitter 22, the estimation device 21 may transmit the estimated position information from the communication transceiver 25 via the control device.

The position information acquisition device 23 acquires position information and a velocity of the mobile object 2. For example, the position information acquisition device 23 can calculate a position and a velocity of the mobile object 2 based on a signal from a global navigation satellite system (GNSS) and input the position and velocity to the estimation device 21.

The communication transceiver 25 is a device that receives a command signal from the earth station 3 and transmits a telemetry signal to the earth station 3 and includes a communication antenna. The command signal is a signal including command data for controlling the mobile object 2. The command signal is a signal by which the control device 26 controls each component and is transmitted from the communication transceiver 25 to the control device 26. The telemetry signal is a signal including telemetry data indicating a state of the mobile object 2. The communication transceiver 25 demodulates the received command signal and outputs the demodulated signal to the control device 26. The communication transceiver 25 modulates a telemetry signal and transmits the modulated telemetry signal to the earth station 3 via the communication transceiver 25.

The control device 26 is constituted by one or more computers and/or one or more processing circuits and totally controls the mobile object 2. For example, the control device 29 can control the receiver 20, the estimation device 21, the transmitter 22, the position information acquisition device 23, the communication transceiver 25, and the storage device 27. The storage device 27 is constituted by a memory and/or a storage, and stores information necessary for performing control and the like of the mobile object 2. The storage device 27 may store a program necessary for controlling the mobile object 2, and each device may be implemented by executing the program by the one or more computers and/or the one or more processing circuits, or these functions may be enabled by hardware configuring an electronic circuit or the like for enabling a part or all of each function.

The earth station 3 is a system that communicates with the mobile object 2. The earth station 3 may be fixedly installed on the ground or may be disposed in a mobile object that can move on the ground, on the sea, or in the sky above the ground surface or the sea surface.

The earth station 3 includes a communication transceiver 30, a control device 31, and a storage device 32.

The communication transceiver 30 includes an antenna for transmitting a command signal and receiving a telemetry signal and generates and transmits a command signal by modulating a control signal for the mobile object 2. Further, the communication transceiver 30 receives and demodulates a telemetry signal and outputs the result to the control device 31. The communication transceiver 30 is further assumed to be capable of receiving a signal including the estimated position information transmitted from the transmitter 22 of the mobile object 2, but the signal including the estimated position information may be received by another receiver.

The control device 31 includes an input/output device, and a computer and/or a processing circuit, and generates a control signal for the mobile object 2. The storage device 32 is constituted by a memory and/or a storage, and stores information necessary for performing control and the like of the earth station 3. The storage device 27 may store a program necessary for performing control of the mobile object, and each device may be implemented by executing the program by the one or more computers and/or the one or more processing circuits, or these functions may be enabled by hardware configuring an electronic circuit or the like for enabling a part or all of each function. The storage device 27 may further store the received estimated position. This allows, for example, the position of a ship transmitting a signal to be specified, and thus, necessary processing can be executed for the ship.

In the present embodiment, the estimation device 21 is included in the mobile object 2, but a part or all of the estimation device 21 may be provided in the earth station 3. For example, the mobile object 2 transmits information indicating a signal received by one mobile object 2, and the earth station 3 receives the information and inputs the information to the estimation device 21 provided in the earth station 3, allowing the position of the signal generation source based on the signal received by the mobile object 2 to be estimated. In still another embodiment, a part or all of the estimation device 21 may be provided in a device other than the mobile object 2 and the earth station 3, or the estimation device 21 may be installed alone, and then the position estimation of the signal generation source may be executed by receiving the signal received by the mobile object 2 through the communication device provided in the estimation device 21.

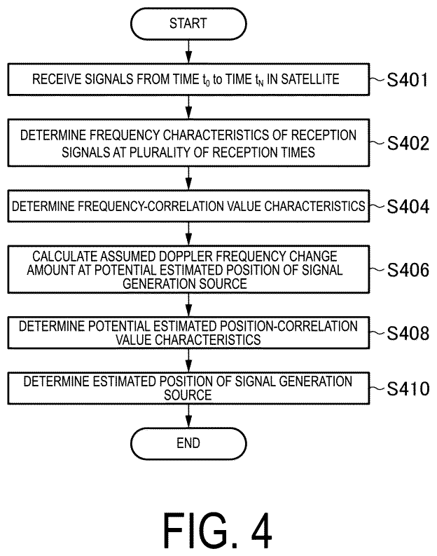

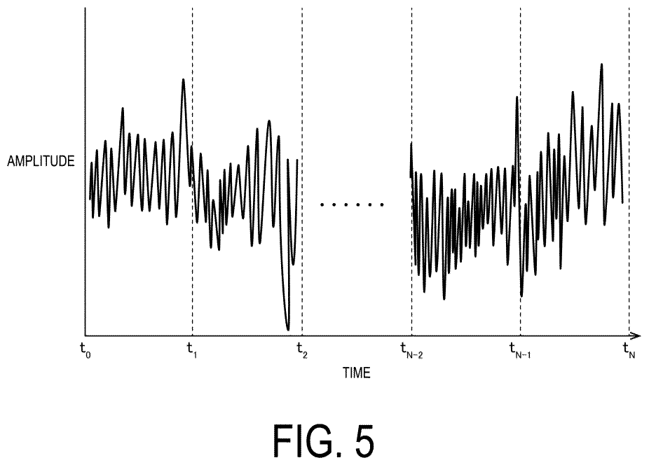

Next, the operation of the estimation system 1 in the present embodiment will be described with reference to FIG. 4. First, the receiver 20 of the artificial satellite 2, which is a single mobile object, receives a radio wave or Terahertz wave signal for a predetermined period, for example, from time t₀ to time t_{N} (S401). As illustrated in FIG. 5, the receiver 20 divides the received radio wave or Terahertz wave at times t₀, t₁, t₂, t₃, . . . , t_{N}, samples a time-axis waveform at each divided time at a sampling frequency fₛ, converts the time-axis waveform into a digital signal representing the time-axis waveform, and outputs the digital signal to the estimation device 21.

The estimation device 21 determines frequency characteristics of the reception signal at each of times to, t₁, t₂, t₃, . . . , t_{N} based on the input digital signal representing the time-axis waveform (S402). In the present embodiment, the frequency characteristics are determined based on the time-axis waveform by using the fast Fourier transform (FFT), but any method may be used as long as the frequency characteristics of the reception signal can be obtained.

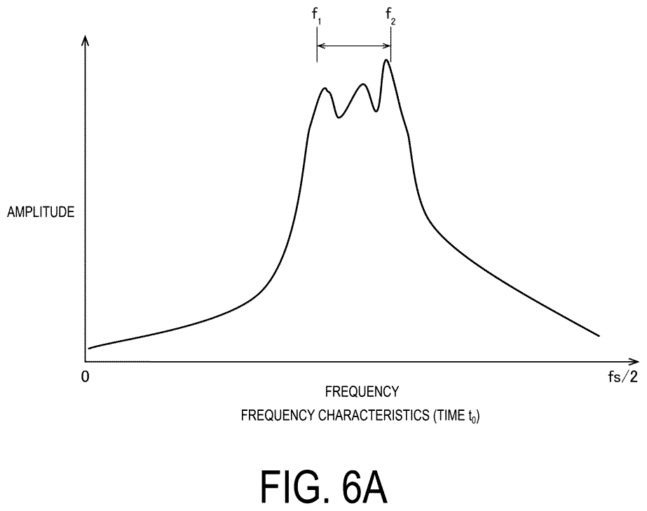

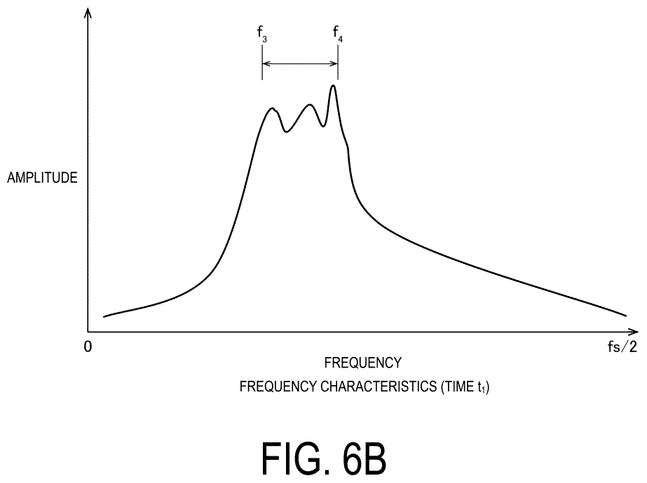

Since the artificial satellite 2 receives a radio wave or Terahertz wave while moving, the radio wave or Terahertz wave signal having a signal frequency f_{org} transmitted from the signal transmission source is received at a Doppler frequency f_{d} affected by the Doppler effect (the transmission signal frequency f_{org}+a shift amount 8 due to the Doppler effect) according to the relative moving velocity of the signal transmission source relative to the artificial satellite 2 that is the signal generation source. In the present embodiment, it is assumed that the moving velocity of the artificial satellite 2 is sufficiently higher than the moving velocity of the signal transmission source and thus the signal transmission source is not moving. As an example, frequency characteristics at time to and time t₁ are illustrated in FIGS. 6A and 6B. The frequency characteristics indicate a relationship between frequencies and the magnitudes of amplitudes. For example, FIG. 6A illustrates frequency characteristics indicating large amplitudes between frequencies f₁ and f₂, and FIG. 6B illustrates frequency characteristics indicating large amplitudes between frequencies f₃ and f₄. That is, it is considered that a signal whose Doppler frequency is between frequencies f₁ and f₂ has been received at time to, and a signal whose Doppler frequency is between frequencies f₃ and f₄ has been received at time t₁. In this case, it is considered that there is a possibility that although signals have been received from the same signal generation source, the Doppler frequency has changed due to a change in magnitude of the Doppler effect on the radio wave or Terahertz wave received from the signal transmission source because the artificial satellite 2 has moved at a predetermined velocity.

Next, the estimation device 21 determines frequency-correlation value characteristics (S404). The frequency-correlation value characteristics indicate a correlation relationship between two frequency characteristics. A method of determining the frequency-correlation value characteristics may be any method that can determine a correlation relationship between two frequency characteristics. In the present embodiment, a method of determining signal correlation processing (Cross-correlation) between two signals is used. Cross-correlation, which is the signal correlation processing, is a method of evaluating how similar two signals are to each other. The larger the value is, the more similar the two signals are. Cross-correlation in the frequency domain of the signals is expressed by the following Equation (1).

$$[ Math . 1 ]$$

$$corr ( {F}_{ti} , {F}_{tx} ) = {F}_{ti}^{*} {F}_{tx} \qquad ( 1 )$$

F*ₜᵢ: frequency characteristics of a signal corresponding to time tᵢ (* means the Hermitian transpose)

Fₜₓ: frequency characteristics of a signal corresponding to time tₓ

Here, it is considered that the frequency characteristics of F*ₜᵢ is shifted by u, which takes various values, on the frequency axis to obtain correlation as expressed in the following Equation (2).

$$[ Math . 2 ]$$

$${corr}_{j} ( u ) = {F ( f + u )}_{ti}^{*} {F}_{tx} ( f ) \qquad ( 2 )$$

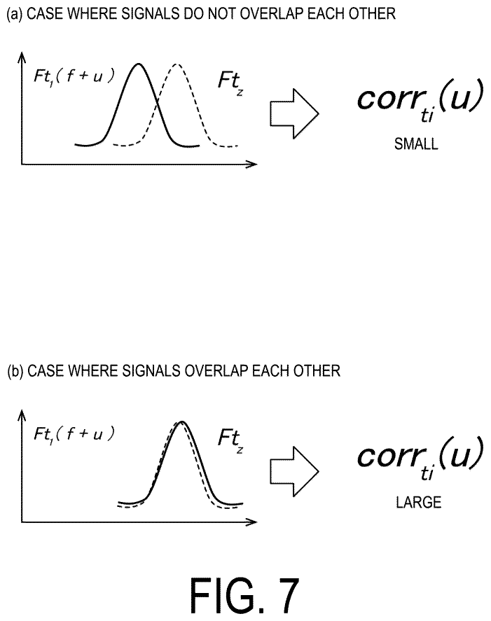

As described above, Cross-correlation indicates a high correlation value when two signals are similar to each other. When two reception signals received at different times are transmitted from the same signal generation source, since the frequency characteristics are similar to each other, it is considered that a high correlation value is indicated. When the receiver receives a signal while moving, the signal is received at different Doppler frequencies, so that the frequency characteristics shift in the frequency axis direction by a Doppler frequency change amount. Thus, as illustrated in FIG. 7(a), even when the two reception signals are signals from the same transmission source, the two signals do not overlap each other, so that the correlation value becomes small. In the present embodiment, in order to determine whether or not two reception signals are similar to each other when the Doppler frequency is displaced due to a change in Doppler effect, a correlation value is determined while one of the frequency characteristics is being shifted as expressed in Equation (2). In a case where the two reception signals are signals from the same transmission source, as illustrated in FIG. 7(b), when the magnitude u of the shifted frequency is a frequency corresponding to the Doppler frequency change amount of the two signals, the overlap between the two signals becomes large and a large correlation value is obtained. The Doppler frequency change amount means a frequency difference between a first Doppler frequency affected by the Doppler effect experienced by a first reception signal and a second Doppler frequency affected by the Doppler effect experienced by a second reception signal.

Thus, by determining correlation characteristics between the frequency characteristics of the signals received at the two reception times by using the above Equation (2), the Doppler frequency change amount of the two signals can be estimated.

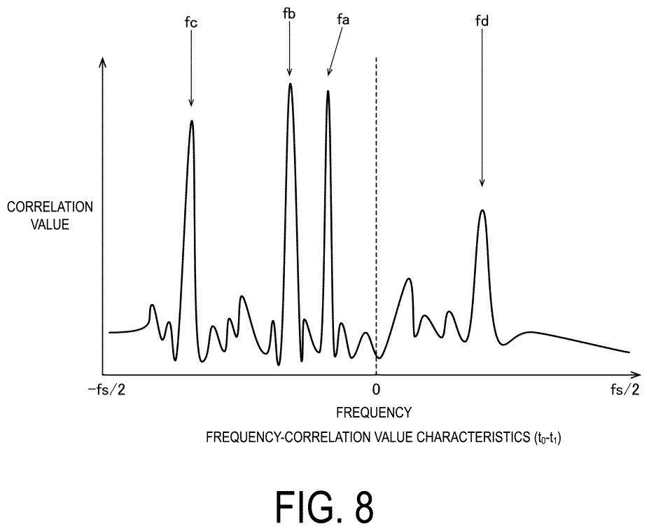

FIG. 8 illustrates frequency-correlation value characteristics between frequency characteristics at time to and time t₁ by using Equation (2). The horizontal axis represents frequencies u obtained by shifting one of the frequency characteristics (Fₜᵢ), and the vertical axis represents correlation values. Since u exhibits high correlation values at fa, fb, fc, and fd, it is estimated that signals having Doppler frequency change amounts corresponding to these frequencies have been received at time to and time t₁. Even when one receiver receives signals, the signals transmitted from the signal transmission sources at different positions experience Doppler effects different from each other. Thus, the frequency band-correlation value characteristics of FIG. 8 exhibiting four peaks indicate that there is a possibility that signals transmitted from four signal transmission sources have been received. Note that one or more peak frequencies may be misdetected in some cases.

In another embodiment, Cross-Ambiguity may be used as signal correlation processing to determine a correlation relationship between two frequency characteristics. In Cross-Ambiguity, in addition to calculating correlation while shifting the frequency, correlation including a delay in a time domain can be taken to obtain a time lag and a frequency shift when two signals overlap each other. Instead of correlation processing in a frequency domain, by calculating Cross-Ambiguity and then obtaining the largest correlation value for each frequency shift, it is possible to determine an estimated position by processing similar to the processing using Cross-Correlation.

In the present embodiment, reception time pairs each of which includes, as one pair, two reception times among a plurality of reception times are determined, and processing for determining the frequency-correlation value characteristics is executed for the two reception times of each determined reception time pair to acquire the frequency-correlation value characteristics for each reception time pair.

Then, in S406, for each reception time pair, the estimation device 21 calculates a Doppler frequency change amount assumed at a potential estimated position of the signal generation source based on positions and velocities of the mobile object 2 that has received the signals at the two reception times of the reception time pair. It is assumed that the position and velocity of the mobile object 2 are acquired from the position information acquisition device 23. For a reception signal at one reception time included in one reception time pair, a first assumed Doppler frequency is determined based on an estimated position, a moving direction, and a velocity of the signal generation source, and for a reception signal at the other reception time, a second assumed Doppler frequency is determined based on an estimated position, a moving direction, and a velocity of the signal generation source, and a difference between the first and second assumed Doppler frequencies is determined to calculate an assumed Doppler frequency change amount for the reception time pair at the position. The potential estimated position may include one or more freely selected points. In the present embodiment, the potential estimated position is a point within a predetermined region on the surface of the earth (the ground and the sea surface) and is specified by a latitude and a longitude.

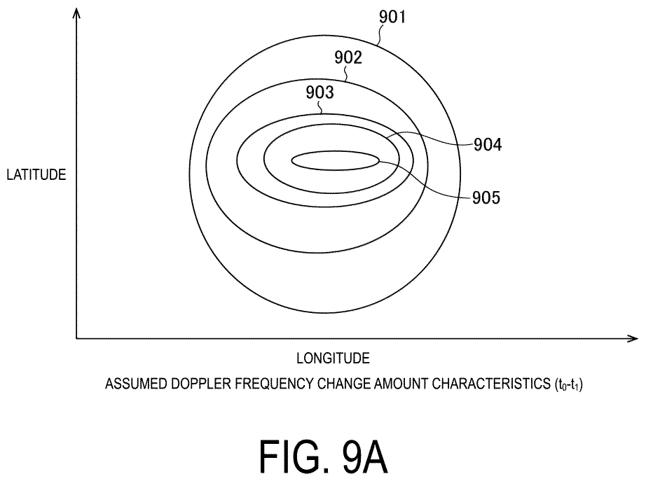

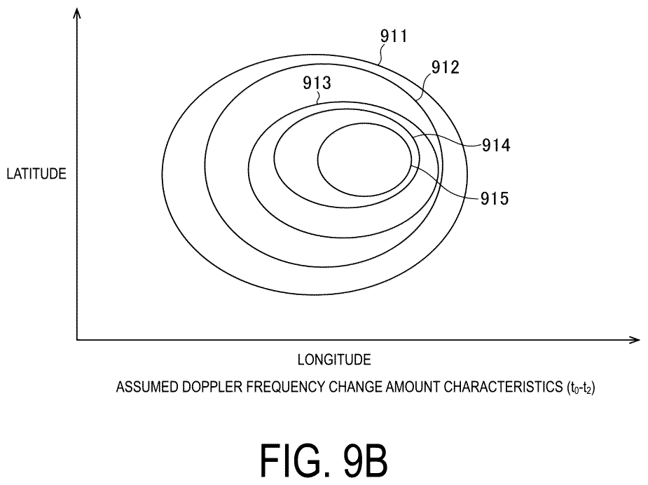

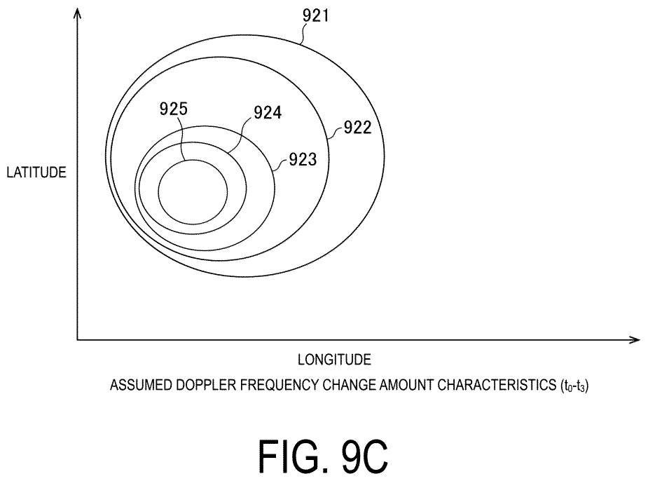

FIGS. 9A to 9C are diagrams individually illustrating assumed Doppler frequency change amount characteristics for three reception time pairs (time t₀ and time t₁, time to and time t₂, and time to and time t₃) at respective latitudes and longitudes. Points connected by lines 901 to 905, 911 to 915 and 921 to 925 mean points at which the same assumed Doppler frequency change amounts f_{d1}, f_{d2}, f_{d3}, f_{d4}, and f_{d5} are assumed, respectively, and indicate contour lines of the f_{d5} assumed Doppler frequency change amount. FIGS. 9A to 9C can also mean maps of the assumed Doppler frequency change amounts with respect to latitudes and longitudes. Although nothing is illustrated for points not indicated by the contour lines in order to simplify the drawing, the assumed Doppler frequency change amounts are calculated also at these points and stored in the storage device of the estimation device 21 in association with each set of latitude and longitude. Here, the assumed Doppler frequency change amount characteristics for each set of latitude and longitude is expressed by a function dfⱼ (lat (latitude), lon (longitude)). The Doppler frequency change amount expressed by the function dfⱼ (lat (latitude), lon (longitude)) may be stored as a table in association with each set of latitude and longitude or may be calculated by sequential operation.

In the present embodiment, one of the reception times included in each reception time pair is common to the reception time pairs at the same time to but need not include the common reception time or may partially overlap the common reception time. For example, the reception time pairs need not include the common reception time, in such a case of defining time to and time t₁, time t₂ and time t₃, and time t₄ and time t₅, or may partially overlap with each other, in such a case of defining time to and time t₁, time t₁ and time t₂, and time t₃ and time t₄. Any time pair may be used as long as the Doppler frequency change amount can be determined between two reception times.

In S408, the estimation device 21 determines potential estimated position-correlation value characteristics indicating a relationship between the potential estimated position and the correlation value for the reception time pair based on the frequency-correlation value characteristics and the assumed Doppler frequency change amount for the reception time pair. The estimation device 21 further determines an estimated position of the signal generation source in S410 based on the potential estimated position-correlation value characteristics for one or more pairs of reception times. In the present embodiment, the estimated position is determined based on a value calculated by a function having, as arguments, correlation values determined based on estimated potential position-correlation value characteristics for a plurality of reception time pairs. Here, the function having the correlation values as the arguments is a function of calculating an integral value of the arguments and can be expressed by the following Equation (3).

$$[ Math . 3 ]$$

$$SumF ( lat , lon ) = {\sum }_{j}^{N} {corr}_{j} ( {df}_{j} ( lat , lon ) ) \qquad ( 3 )$$

corrⱼ is a function indicating a potential estimated position-correlation value characteristics indicating a correlation value for a latitude lat and a longitude lon. An assumed Doppler frequency change amount at each set of latitude lat and longitude lon for a reception time pair j is calculated based on a function dfⱼ for assumed Doppler frequency change amount, and substituted into the function corrⱼ indicating frequency-correlation value characteristics for the reception time pair j to determine a correlation value for the latitude and the longitude. This process is executed for N reception pairs, and an integral value SumF (lat, lon) of the determined correlation values is output. This process is executed for each potential estimated position (latitude, longitude). Then, it is considered that there is a high possibility that a signal is transmitted from a position where the calculated integral value is large. Here, N is a natural number equal to or larger than 1, and N may be equal to 1. However, when N is a plural number equal to or larger than 2, the estimation accuracy of a position can be improved. Increasing the estimation accuracy includes the ability to further limit a range of the estimated position and the ability to reduce the probability of misdetection.

In the present embodiment, a potential estimated position at which the integral value of the correlation values determined based on estimated potential position-correlation value characteristics for the plurality of reception time pairs is equal to or larger than a predetermined value is determined as an estimated position of the signal generation source. However, the predetermined number of potential estimated positions may be determined as estimated positions in a descending order of integral values and may be determined as an estimated position based on integral values by another method.

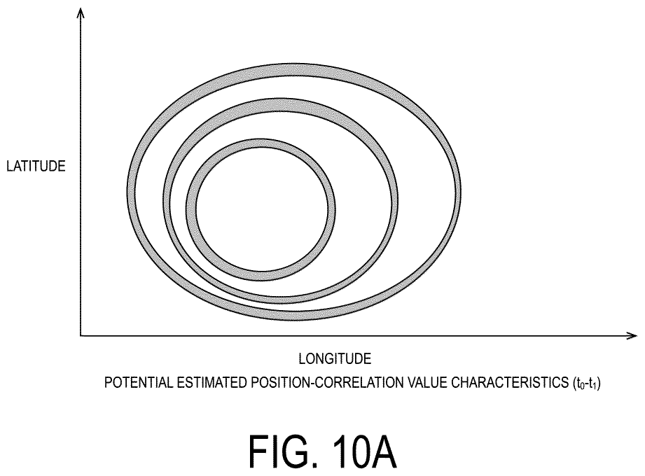

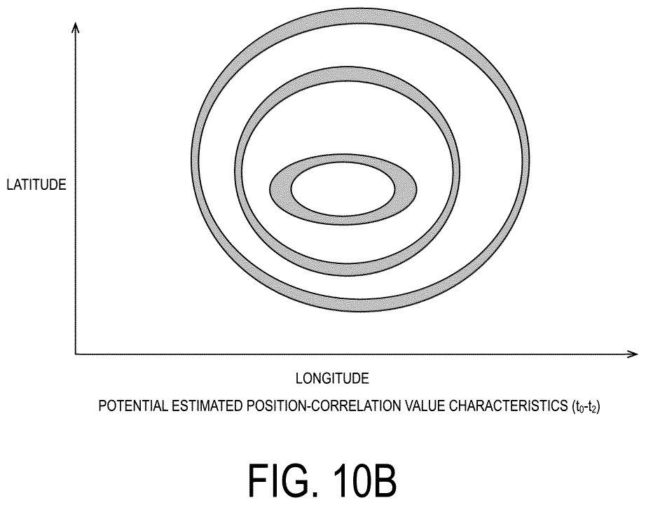

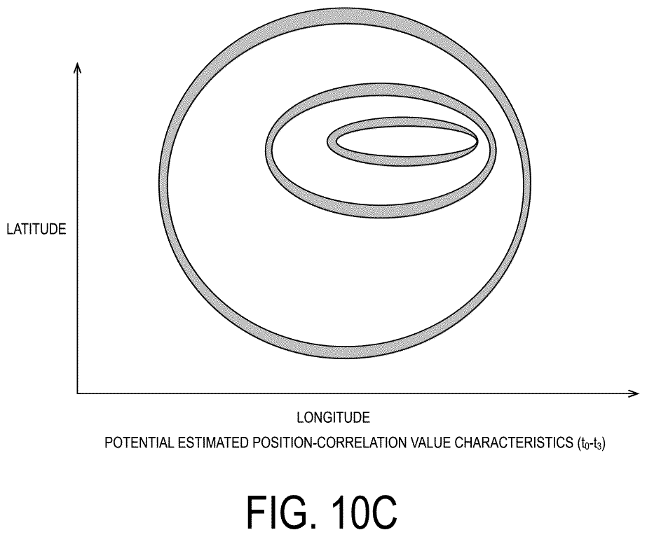

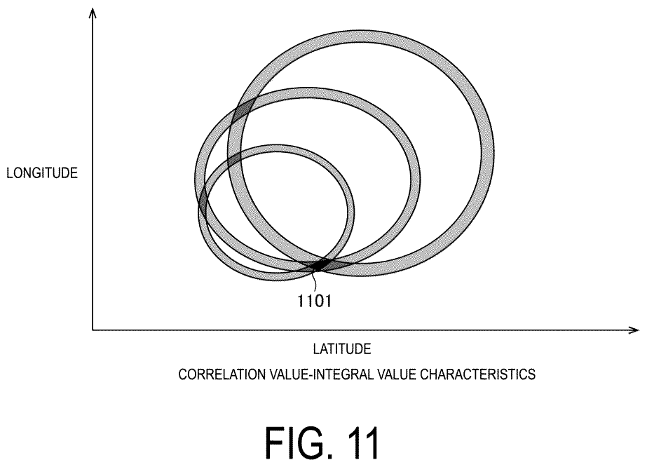

FIGS. 10A to 10C illustrate an example of potential estimated position-correlation value characteristics (maps) representing relationships between correlation values calculated by the function corrⱼ and latitudes and longitudes for three reception time pairs. The vertical axis and the horizontal axis represent latitudes and longitudes, respectively, and portions colored in gray indicate regions having high correlation values. In FIGS. 10A to 10C, the regions having the highest correlation values are indicated in gray for simplification, but each set of latitude and longitude has a correlation value and is stored in the estimation device 21. FIG. 11 is integral value characteristics (map) illustrating relationships between the integrated values of the correlation values for the three reception time pairs and the latitudes and longitudes, and since a position 1101 exhibits an integrated value exceeding a threshold value, this potential estimated position is determined as an estimated position.

When only one reception time pair is used, for example, an estimated position can be determined on the assumption that a signal is transmitted from a certain position in the gray regions illustrated in FIG. 10A.

Although an estimated position is specified by a latitude and a longitude in the present embodiment, it can be clearly understood by those skilled in the art that an estimated position can be specified by using a three-dimensional coordinate system by a method similar to that of the above-described embodiment.

By using the present embodiment, it is possible to estimate a position of the signal generation source without calculating a Doppler shift amount. Although the potential estimated position-correlation position characteristics used in the process of determining the estimated position of the signal generation source may be based on a single pair of reception times, the estimation accuracy can be enhanced by using two or more pairs of reception times.

When a conventional method is used, for example, it is necessary to calculate a value at which the largest peak appears in FIG. 8 as a Doppler shift amount to determine an estimated position based on only the parameter. However, when several peaks appear as in the example illustrated in FIG. 8, there is a possibility that a Doppler shift amount being a highly inaccurate value is determined due to a slight instantaneous error. That is, there is a possibility that a peak of another convex shape is read, and if an inaccurate peak is read, the estimation accuracy of the position is lowered. In the present embodiment, since the correlation value is made to correspond to the potential estimated position as it is, there is no possibility that the parameter with an inaccurate value is read by using an instantaneous value and thus the estimation accuracy is lowered. The estimation is less sensitive to such an outlier because it can be estimated that the position with the largest overlap is likely to be the signal transmission source by overlapping at several reception times.

Further, in the present embodiment, it is possible to estimate a position of the signal generation source based on a reception signal received by a single mobile object. Furthermore, even when there are a plurality of signal generation sources, it is possible to estimate positions of a plurality of signal generation sources based on a reception signal received by a single mobile object.

In another embodiment of the present invention, a program for implementing the functions of the embodiment of the present invention described above and the processing illustrated in the flowchart and a computer-readable storage medium storing the program can be provided. In addition, in another embodiment, a method of implementing the functions of the embodiment of the present invention described above and the processing illustrated in the flowchart can be provided. In addition, in another embodiment, a server that can supply a computer with the program for implementing the functions of the embodiment of the present invention described above and the processing illustrated in the flowchart can be provided. In addition, in another embodiment, a virtual machine that implements the functions of the embodiment of the present invention described above and the processing illustrated in the flowchart can be provided.

In the processing or operations described above, the processing or operations can be modified freely as long as there is no occurrence of contradiction in the processing or operations such as using data that is not yet supposed to be used in a corresponding step. In addition, each embodiment described above is exemplified for describing the present invention, and the present invention is not limited to these examples. The present invention may be implemented in various forms without departing from the scope thereof.

### REFERENCE SIGNS LIST

1: Estimation system
2: Mobile object
3: Earth station
4: Satellite orbit
5: Signal generation source
20: Receiver
21: Estimation device
22: Transmitter
23: Position information acquisition device
25: Communication transceiver
26: Control device
27: Storage device
29: Control device
30: Communication transceiver
31: Control device
32: Storage device
211: Frequency characteristics determination device
212: Frequency-correlation value characteristics determination device
213: Assumed Doppler frequency change amount calculation device
214: Potential estimated position-correlation value characteristics determination device
215: Estimated position determination device

1. An estimation device configured to estimate a position of a signal generation source, the estimation device comprising:
a frequency characteristics determination device configured to determine frequency characteristics of signals received by a single mobile object at a plurality of reception times;
a frequency-correlation value characteristics determination device configured to determine, with respect to a reception time pair that is a pair of two reception times of the plurality of reception times, frequency-correlation value characteristics indicating a relationship between a frequency and a correlation value between the frequency characteristics corresponding to the two reception times included in the reception time pair;
an assumed Doppler frequency change amount calculation device configured to calculate, with respect to the reception time pair, an assumed Doppler frequency change amount at a potential estimated position of the signal generation source, based on positions and velocities of the mobile object at the two reception times included in the reception time pair;
a potential estimated position-correlation value characteristics determination device configured to determine, with respect to the reception time pair, potential estimated position-correlation value characteristics indicating a relationship between the potential estimated position and the correlation value, based on the frequency-correlation value characteristics and the assumed Doppler frequency change amount related to the reception time pair; and
an estimated position determination device configured to determine an estimated position of the signal generation source, based on one or more of the potential estimated position-correlation value characteristics corresponding to one or more of the reception time pairs.

2. The estimation device according to claim 1,
wherein the estimated position determination device determines, as the estimated position of the signal generation source, a potential estimated position at which a value calculated by using a function having, as arguments, correlation values determined based on estimated potential position-correlation value characteristics corresponding to a plurality of the reception time pairs is equal to or larger than a predetermined value.

3. The estimation device according to claim 2,
wherein the function is a function of calculating an integral value of the arguments.

4. The estimation device according to claim 1,
wherein one of the two reception times included in each of a plurality of the reception time pairs is a reception time common to the plurality of reception time pairs, and the other reception time is a reception time different for each pair.

5. The estimation device according to claim 1,
wherein none of the two reception times included in each of the plurality of reception time pairs is a reception time common to the plurality of reception time pairs.

6. A mobile object comprising:
the estimation device according to claim 1.

7. An earth station comprising:
the estimation device according to claim 1.

8. An estimation system comprising one or more mobile objects and one or more earth stations and configured to estimate a position of a signal generation source, the estimation system comprising:
a frequency characteristics determination device configured to determine frequency characteristics of signals received by a single mobile object at a plurality of reception times;
a frequency-correlation value characteristics determination device configured to determine, with respect to a reception time pair that is a pair of two reception times of the plurality of reception times, frequency-correlation value characteristics indicating a relationship between a frequency and a correlation value between the frequency characteristics corresponding to the two reception times included in the reception time pair;
an assumed Doppler frequency change amount calculation device configured to calculate, with respect to the reception time pair, an assumed Doppler frequency change amount at a potential estimated position of the signal generation source, based on positions and velocities of the mobile object at the two reception times included in the reception time pair;
a potential estimated position-correlation value characteristics determination device configured to determine, with respect to the reception time pair, potential estimated position-correlation value characteristics indicating a relationship between the potential estimated position and the correlation value, based on the frequency-correlation value characteristics and the assumed Doppler frequency change amount related to the reception time pair; and
an estimated position determination device configured to determine an estimated position of the signal generation source, based on one or more of the potential estimated position-correlation value characteristics corresponding to one or more of the reception time pairs.

9. The estimation system according to claim 8,
wherein each of the devices is included in either of the one or more mobile objects or the one or more earth stations.

10. The estimation system according to claim 8,
wherein each of the devices is provided in a distributed manner in the one or more mobile objects and the one or more earth stations.

11. A method of estimating a position of a signal generation source, the method comprising:
causing one or more computers
to determine frequency characteristics of signals received by a single mobile object at a plurality of reception times,
to determine, with respect to a reception time pair that is a pair of two reception times of the plurality of reception times, frequency-correlation value characteristics indicating a relationship between a frequency and a correlation value between the frequency characteristics corresponding to the two reception times included in the reception time pair,
to calculate, with respect to the reception time pair, an assumed Doppler frequency change amount at a potential estimated position of the signal generation source, based on positions and velocities of the mobile object at the two reception times included in the reception time pair,
to determine, with respect to the reception time pair, potential estimated position-correlation value characteristics indicating a relationship between the potential estimated position and the correlation value, based on the frequency-correlation value characteristics and the assumed Doppler frequency change amount related to the reception time pair, and to determine an estimated position of the signal generation source, based on one or more of the potential estimated position-correlation value characteristics corresponding to one or more of the reception time pairs.

12. A non-transitory computer readable medium storing a program configured to cause one or more computers to execute the method according to claim 11.
